(19) United States
(12) Patent Application Publication
(10) Pub. No.: US 2014/0296470 A1
(43) Pub. Date: Oct. 2, 2014

(54) RESIN MATERIAL AND PROTECTIVE FILM

(71) Applicant: FUJI XEROX CO., LTD., Tokyo (JP)

(72) Inventor: Hisae YOSHIZAWA, Kanagawa (JP)

(73) Assignee: FUJI XEROX CO., LTD., Tokyo (JP)

(21) Appl. No.: 13/966,793

(22) Filed: Aug. 14, 2013

(30) Foreign Application Priority Data
Mar. 26, 2013 (JP) 2013-064977

(51) Int. Cl. C08G 18/67

(52) U.S. Cl. CPC C08G 18/6705
USPC 528/75

(57) ABSTRACT

Disclosed is a resin material which is formed by polymerization of an acrylic resin containing a side chain having a hydroxyl group and a side chain having a fluorine atom, at least one kind of polyol having a weight-average molecular weight from 300 to 5000 and selected from compounds represented by the following Formula (A), and an isocyanate.

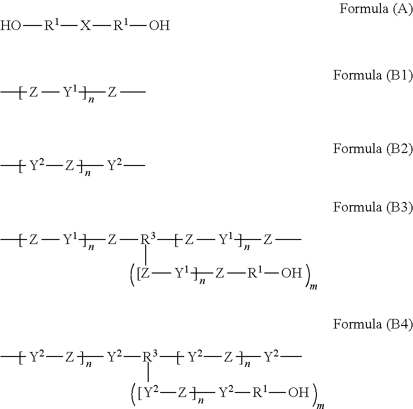

### CROSS-REFERENCE TO RELATED APPLICATIONS

This application is based on and claims priority under 35 USC 119 from Japanese Patent Application No. 2013-064977 filed Mar. 26, 2013.

### BACKGROUND

1. Technical Field

The present invention relates to a resin material and a protective film.

2. Related Art

In the related art, in various fields, a resin material has been used as a protective film or the like for a surface for the purpose of suppressing damage on the surface. The resin material is used in a portable device that has a screen such as a mobile phone or a portable game device, window glass, lenses of glasses, window glass or body of a car, a recording surface of an optical disc such as a CD, a DVD, or a BD, a solar cell panel, an endless belt or roll for an image forming apparatus used for a fixing member, an intermediate transferring member, or a recording medium transporting member of the image forming apparatus, a transparent plate for platen (platen glass) on which a document is placed for optically reading an image in the image forming apparatus or a scanner, a protective film of a document reading apparatus of a facsimile, a floor, or a mirror, for example.

### SUMMARY

According to an aspect of the invention, there is provided a resin material which is formed by polymerization of an acrylic resin containing a side chain having a hydroxyl group and a side chain having a fluorine atom, at least one kind of polyol having a weight-average molecular weight from 300 to 5000 and selected from compounds represented by the following Formula (A), and an isocyanate:

HO—R¹—X—R¹—OH Formula (A)

wherein in Formula (A), X represents any group selected from the following Formulae (B1) to (B4); and R¹ represents an alkylene group having 1 to 6 carbon atoms, a fluorinated alkylene group having 1 to 8 carbon atoms, or a single bond; in a case where R¹ is a single bond, X represents any group selected from the following Formulae (B2) and (B4):

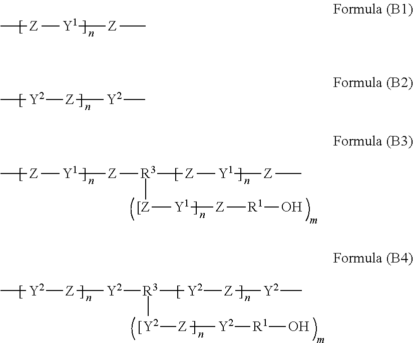

wherein in Formulae (B1) to (B4), Y¹ represents the same group as R¹ of Formula (A) or —Si(R²)₂—; Y² represents —Si(R²)₂—; Z represents —OC(═O)O—, —C(═O)O—, or —O—; R² represents —H, —CH₃, or —CF₃; R³ represents an alkyl group having 1 to 6 carbon atoms or a fluorinated alkyl group having 1 to 6 carbon atoms, each having (m+2)-valent bond; m represents an integer from 1 to 3; and n represents an integer equal to or larger than 1; a plurality of n in Formulae (B3) and (B4) may be same with each other or different from each other; and R¹ of Formulae (B3) and (B4) represents the same group as R¹ of Formula (A).

### BRIEF DESCRIPTION OF THE DRAWINGS

Exemplary embodiments of the present invention will be described in detail based on the following figures, wherein:

FIG. 1 is a perspective view showing a schematic configuration of an endless belt according to the exemplary embodiment;

FIG. 2 is a cross-sectional view of an endless belt according to the exemplary embodiment; and

FIG. 3 is a schematic configuration view showing an image fixing device using an endless belt according to the exemplary embodiment.

### DETAILED DESCRIPTION

Exemplary embodiments of the present invention will be described hereinafter.

Resin Material

A resin material according to the exemplary embodiment is formed by polymerization of an acrylic resin containing a side chain having a hydroxyl group, polyol, and isocyanate. The acrylic resin also contains a side chain having a fluorine atom. In addition, as polyol, at least one kind having a weight-average molecular weight from 300 to 5000 and selected from compounds represented by the following Formula (A) is used.

HO—R¹—X—R¹—OH Formula (A)

In Formula (A), X represents any group selected from the following Formulae (B1) to (B4), and R¹ represents an alkylene group having 1 to 6 carbon atoms, a fluorinated alkylene group having 1 to 8 carbon atoms, or a single bond. Herein, in a case where R¹ is a single bond, X represents any group selected from the following Formulae (B2) and (B4).

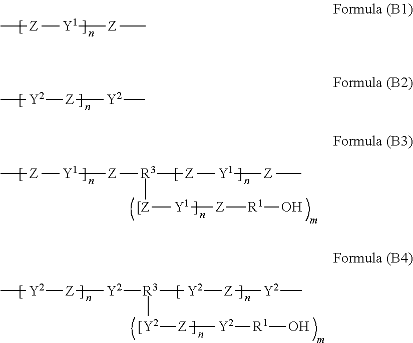

In Formulae (B1) to (B4), Y¹ represents the same group as R¹ of Formula (A) or —Si(R²)₂—, Y² represents —Si (R²)₂—, Z represents —OC(═O)O—, —C(═O)O—, or —O—, R² represents —H, —CH₃, or —CF₃, R³ represents an alkyl group having 1 to 6 carbon atoms or a fluorinated alkyl group having 1 to 8 carbon atoms, each having (m÷2)-valent bond, m represents an integer from 1 to 3, and n represents an integer equal to or larger than 1. Herein, plural ns in Formulae (B3) and (B4) may be the same with each other or different from each other. R¹ of Formulae (B3) and (B4) represents the same group as R¹ of Formula (A).

In a resin material which is formed by polymerization of an acrylic resin containing a side chain having a hydroxyl group and isocyanate and has a self-repairing function, flexibility is degraded due to high cross-link density in some cases. Accordingly, when a force that causes damage on a surface is applied, the damage is repaired by the self-repairing function and thus the damaging is suppressed, however, when a greater force is applied, the resin material itself may be easily broken in some cases.

With respect to this, the resin material according to the exemplary embodiment is formed by further polymerization of polyol represented by Formula (A), in addition to the acrylic resin and isocyanate. It is considered that, by interposing the polyol represented by Formula (A) between cross-linking of the acrylic resin and the isocyanate, while maintaining the self-repairing function of the resin material, flexibility is additionally given, and thus, a strong resin material which is hardly broken is obtained in the exemplary embodiment. In addition, heat resistance is also improved by the constitution described above.

However, from a viewpoint of giving a release property to the resin material, in a case of additionally using an acrylic resin containing a side chain having a fluorine atom as the acrylic resin, the polyol represented by Formula (A) is separated from the acrylic resin or isocyanate, and strength against the fracture is not obtained, in some cases. In addition, the separated polyol is aggregated and the resin material yields a white turbidity, in some cases.

With respect to this, the resin material according to the exemplary embodiment is formed by polymerization of polyol having weight-average molecular weight in the range described above, as the polyol represented by Formula (A). It is considered that the polyol is mixed with the acrylic resin and isocyanate in an excellent manner, and thus a resin material in which polyol is efficiently interposed between cross-linking of an acrylic resin and isocyanate is obtained. As a result, in the exemplary embodiment, a strong resin material which maintains a self-repairing function, has flexibility, and is hardly broken, is obtained. In addition, a white turbidity of the resin material is suppressed.

Next, a composition of the resin material according to the exemplary embodiment will be described.

Acrylic Resin

The acrylic resin of the exemplary embodiment contains a side chain having a hydroxyl group and a side chain having a fluorine atom. For manufacturing the acrylic resin, a monomer having a hydroxyl group and a monomer having a fluorine atom are used, and a monomer not having a hydroxyl group and a fluorine atom may be additionally used with them.

As the monomer having a hydroxyl group, an ethylene monomer having a hydroxyl group such as hydroxymethyl (meth)acrylate, hydroxyethyl (meth)acrylate, hydroxylpropyl (meth)acrylate, hydroxybutyl (meth)acrylate, or N-methylol acrylamine is used.

In addition, the hydroxyl group of the acrylic resin of the exemplary embodiment may be a carboxyl group. Accordingly, a monomer having a carboxyl group may be used as a monomer having a hydroxyl group, and as a detailed example thereof, an ethylene monomer having a carboxyl group such as (meth)acrylic acid, crotonic acid, itaconic acid, fumaric acid, or maleic acid is used.

The monomer having a fluorine atom is not particularly limited as long as it contains a fluorine atom. As the constitutional unit derived from the monomer having a fluorine atom, the number of carbon atoms on a side chain is from 2 to 20, for example. The carbon chain on the side chain of the constitutional unit derived from the monomer having a fluorine atom may be linear or branched.

The number of fluorine atoms contained in one molecule of the monomer having a fluorine atom is not particularly limited, however, it is preferably from 1 to 25, and more preferably from 3 to 17.

Detailed examples of the monomer having a fluorine atom include 2-(perfluorobutyl)ethyl acrylate, 2-(perfluorohexyl)ethyl acrylate, (perfluorohexyl)ethyl methacrylate, perfluorohexyl ethylene, hexafluoropropene, hexafluoropropene epoxide, or perfluoro (propyl vinylether).

An addition rate of the fluorine atom with respect to the acrylic resin is preferably from 0.1% by weight to 50% by weight, and more preferably from 1% by weight to 20% by weight.

Examples of the monomer not having a hydroxyl group and a fluorine atom include ethylene monomers such as alkylester (meth)acrylate such as methyl (meth)acrylate, ethyl (meth)acrylate, propyl (meth)acrylate, butyl (meth)acrylate, n-propyl (meth)acrylate, n-butyl (meth)acrylate, isobutyl (meth)acrylate, 2-ethylhexyl (meth)acrylate, n-octyl (meth)acrylate, and n-dodecyl (meth)acrylate.

As a synthesis method of the acrylic resin, a method of mixing a monomer such as the monomer having a hydroxyl group or the monomer having a fluorine atom, performing radical polymerization or ionic polymerization, and then, perform purification.

A hydroxyl value of the acrylic resin is preferably from 50 mgKOH/g to 400 mgKOH/g, more preferably from 70 mgKOH/g to 250 mgKOH/g, and even more preferably from 100 mgKOH/g to 250 mgKOH/g.

In the resin material according to the exemplary embodiment, the acrylic resin may be used alone as one kind or in combination of two or more kinds.

Polyol

The polyol of the exemplary embodiment is represented by the following Formula (A).

HO—R¹—X—R¹—OH Formula (A)

In Formula (A), X represents any group selected from the following Formulae (B1) to (B4), and R¹ represents an alkylene group having 1 to 6 carbon atoms, a fluorinated alkylene group having 1 to 8 carbon atoms, or a single bond. Herein, in a case where R¹ is a single bond, X represents any group selected from the following Formulae (B2) and (B4).

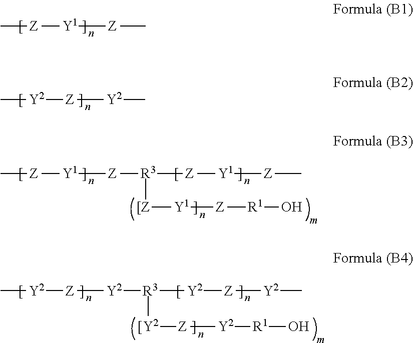

In Formulae (B1) to (B4), Y¹ represents the same group as R¹ of Formula (A) or —Si(R²)₂—, Y² represents —Si(R²)₂—, Z represents —OC(═O)O—, —C(═O)O—, or —O—, R² represents —H, —CH₃, or —CF₃, R³ represents an alkyl group having 1 to 6 carbon atoms or a fluorinated alkyl group having 1 to 6 carbon atoms, each having (m+2)-valent bond, m represents an integer from 1 to 3, and n represents an integer equal to or larger than 1. Herein, plural ns in Formulae (B3) and (B4) may be same with each other or different from each other. R¹ of Formulae (B3) and (B4) represents the same group as R¹ of Formula (A).

That is, the terminal of polyol represented by Formula (A) is modified with hydroxyl alkyl, hydroxyl fluorinated alkyl, or hydroxyl, and a repeating unit including at least a —OC(═O)O— group, a —C(═O)O— group, or a —O— group is included therebetween. In addition, bifunctional polyol is represented in a case where X of Formula (A) is Formula (B1) or (B2), and on the other hand, trifunctional or higher functional polyol is represented in a case where X is Formula (B3) or (B4).

Examples of the alkylene group represented by R¹ include C₂H₄, CH₂, CH(CH₃)CH₂, C₆H₆, —C(CH₃)₂—, CH₂C₆H₁₀CH₂, and the like.

Examples of the fluorinated alkylene group represented by R¹ include CF₂—CH₂, CF₂, CF₂CF₂CF₂, and the like.

R² of Si(R²)₂ represents —H, —CH₃, or —CF₃ as described above, and —CH₃ is more preferable among them.

R³ has (m+2)-valent bond.

Examples of the alkyl group represented by R³ include CH, C₄H₇, C₆H₆, and the like.

Examples of the fluorinated alkyl group represented by R³ include CF₂CFCF₂CF₂, and the like.

Examples of the polyol represented by Formula (A) include polycarbonate polyol, polyester polyol, polyether polyol, alcohol modified polysilicone, and other polyol which will be described later.

(1) Polycarbonate Polyol

Examples of polycarbonate polyol include bifunctional polyol represented by the following Formula (A1-1) and trifunctional or higher functional polyol represented by the following (A1-2). In addition to the case where R¹ is an alkylene group, as represented by the following Formulae (A1-1) and (A1-2), fluorine polycarbonate polyol in which R¹ is a fluorinated alkylene group is also used, as polycarbonate polyol.

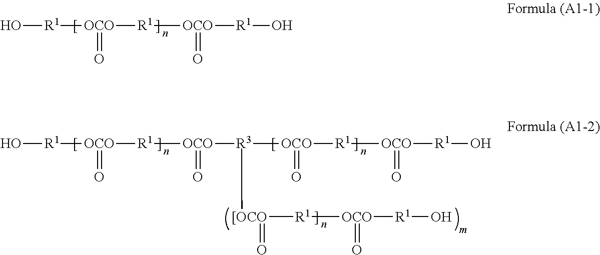

R¹, R³, n, and m of Formulae (A1-1) and (A1-2) are the same as those in the case of Formula (A) and Formulae (B1) to (B4).

Examples of the polycarbonate polyol represented by Formula (A1-1) or (A1-2) include ETERNACOLL-UH and ETERNACOLL-UC (manufactured by Ube Industries, Ltd.).

(2) Polyester Polyol

Examples of polyester polyol include bifunctional polyol represented by the following Formula (A2-1) and trifunctional or higher functional polyol represented by the following (A2-2). In addition to the case where R¹ is an alkyl group, as represented by the following Formulae (A2-1) and (A2-2), fluorine polyester polyol in which R¹ is a fluorinated alkyl group is also used, as polyester polyol.

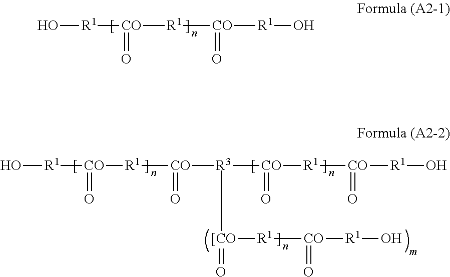

R¹, R³, n, and m of Formulae (A2-1) and (A2-2) are the same as those in the case of Formula (A) and Formulae (B1) to (B4).

Examples of the polyester polyol represented by Formula (A2-1) or (A2-2) include PLACCEL 208 and PLACCEL 312 (manufactured by Daicel Corporation), POLYLIGHT ODX-286, and POLYLIGHT ODX-2586 (manufactured by DIC Corporation).

(3) Polyether Polyol

Examples of polyether polyol include bifunctional polyol represented by the following Formula (A3-1) and trifunctional or higher functional polyol represented by the following (A3-2). In addition to the case where R¹ is an alkyl group, as represented by the following Formulae (A3-1) and (A3-2), fluorine polyether polyol in which R¹ is a fluorinated alkyl group is also used, as polyether polyol.

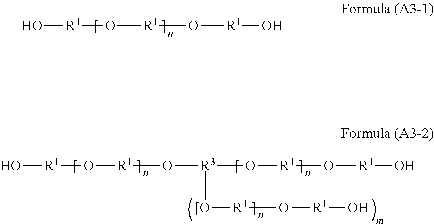

R¹, R³, n, and m of Formulae (A3-1) and (A3-2) are the same as those in the case of Formula (A) and Formula (B1) to Formula (B4).

Examples of polyether polyol represented by Formula (A3-1) or (A3-2) include EXCENOL and PREMINOL (manufactured by Asahi Glass Co., Ltd.), and PEG #1000 (manufactured by Lion Corporation).

(4) Alcohol Modified Polysilicone

Examples of the alcohol modified polysilicone include bifunctional polyol represented by the following Formula (A4-1) and trifunctional or higher functional polyol represented by the following (A4-2). In addition, the alcohol modified polysilicone may be represented by the following Formula (A5-1) or Formula (A5-2).

In addition to the alkylalcohol modified polysilicone in which R¹ is an alkyl group, as represented by the following Formulae (A4-1) and (A4-2) and Formulae (A5-1) and (A5-2), fluorinated alkyl alcohol modified polysilicone in which R¹ is a fluorinated alkyl group is also used, as alcohol modified polysilicone. In a case of the following Formulae (A4-1) and (A4-2), alcohol modified polysilicone in which R¹ is a single bond is used.

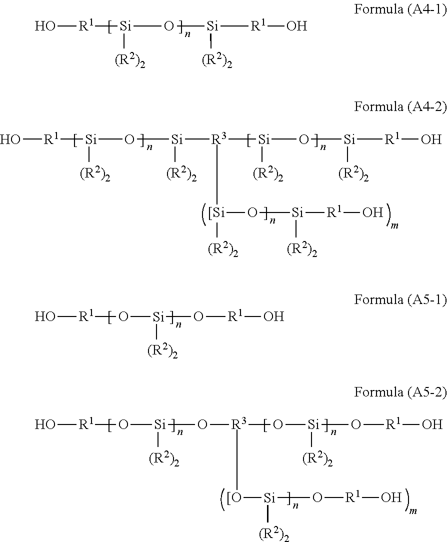

R¹, R², R³, n, and m of Formulae (A4-1), (A4-2), (A5-1), and (A5-2) are the same as those in the case of Formula (A) and Formulae (B1) to (B4).

Examples of alkylalcohol modified polysilicone represented by Formulae (A4-1) and (A4-2) include SF8427 and BY16-201 (manufactured by Dow Corning Toray Co., Ltd.)

Among the polyol represented by Formula (A), (1) polycarbonate polyol represented by Formula (A1-1) or Formula (A1-2), (2) polyester polyol represented by Formula (A2-1) or Formula (A2-2), (3) polyether polyol represented by Formula (A3-1) or Formula (A3-2), and (4) alcohol modified polysilicone represented by Formula (A4-1) or Formula (A4-2) are preferable.

In addition, for the polyol represented by Formula (A), the number of functional groups is preferably from 2 to 4.

Weight-average molecular weight of the polyol represented by Formula (A) is in a range of 300 to 5000 and is preferably in a range of 500 to 2000.

When the weight-average molecular weight of the polyol represented by Formula (A) exceeds the upper limit value, the polyol is separated from the acrylic resin or isocyanate, and strength against the fracture is not obtained. On the other hand, when the weight-average molecular weight thereof is lower than the lower limit value, it is considered that the flexibility, which is obtained by the polyol interposed between cross-link of the acrylic resin and isocyanate, is not obtained, and as a result, the strength against the fracture is not obtained.

In addition, the weight-average molecular weight of polyol is measured by the following method.

The polymer obtained by synthesis is analyzed at different temperatures, by using a pyrolysis gas chromatography-mass spectrometer (Py-GC/MS). When a minimum unit monomer of the polyol is present at a high temperature, the integral multiple peak of MS is checked with low-temperature decomposition spectrum, and weight-average molecular weight is acquired from spectrum with maximum molecular weight.

A hydroxyl value of the polyol represented by Formula (A) is preferably from 30 mgKOH/g to 400 mgKOH/g, and more preferably from 100 mgKOH/g to 250 mgKOH/g.

When the hydroxyl value of the polyol represented by Formula (A) is in the range described above, the separation of polyol from the acrylic resin or isocyanate is suppressed, and the preferable strength against the fracture is obtained.

In addition, the hydroxyl value represents mg number of potassium hydroxide necessary for acetylation of the hydroxyl group in 1 g of a sample. The measurement of the hydroxyl value of the exemplary embodiment is performed based on a method (potentiometer titration) given by JIS K0070-1992. However, when sample is not dissolved, a solvent such as dioxane or THF is used.

A ratio (b)/(a) of total molar amount (a) of the hydroxyl group contained in the total acrylic resin used for polymerization and total molar amount (b) of the hydroxyl group contained in the total polyol used for polymerization is preferably from 0.1 to 10 and more preferably from 0.5 to 3.

Isocyanate

The isocyanate functions as a cross-linking agent for cross-linking of the acrylic resin and the polyol, the acrylic resin and the acrylic resin, or the polyol and the polyol. Examples of the isocyanate are not particularly limited, however, they include methylene diisocyanate, toluene diisocyanate, hexamethylene diisocyanate, and isophorone diisocyanate. In addition, the isocyanate may be used alone as one kind or may be used in combination of two or more kinds.

As the additive amount of the isocyanate, the molar number (c) of the isocyanate group to be added is preferably in a range of from 0.5 time to 3 times the total molar number ((d)+(e)) of the molar number (d) of the hydroxyl group of the acrylic resin and the molar number (e) of the hydroxyl group of the polyol.

Polymerization Method

Next, a method of forming the resin material (polymerization method of the resin) according to the exemplary embodiment will be described.

A method of forming a sample will be described. As an example, the acrylic resin, polyol, and isocyanate are mixed to each other, and the obtained mixture is casted on a film of polyimide after defoaming under reduced pressure, to form a sample of a resin layer, and by heating and curing the sample (for example, at 85° C. for 60 minutes, and at 130° C. for 30 minutes), a resin material is formed. In practice, after coating on a surface to be protected, heating and curing are performed in the same manner.

Usage

The resin material according to the exemplary embodiment which is obtained as described above may be used without any particular limitation, as long as it is used with respect to an object in which scratch may be generated on a surface by the contact with a foreign material. Examples of the object in which scratch may be generated on a surface by contact with a foreign material, include a screen of a portable device such as a mobile phone or a portable game device, window glass, lenses of glasses, window glass or body of a car, a recording surface of an optical disc such as a CD, a DVD, or a BD, a solar cell panel, an endless belt or roll for an image forming apparatus used for a fixing member, an intermediate transferring member, or a recording medium transporting member of the image forming apparatus, a floor, and a mirror.

In the screen of a portable device such as a mobile phone or a portable game device, scratch is generated due to scraping by the contact of a tip of a finger (nail) or tip end of a stick for operation.

In addition, for the window glass, or the window glass or body of a car, scratch is generated from various reasons such as the contact with sand, leaves, a tree branch transported by wind, or the contact with insects, since it is exposed to the natural environment.

For the lenses of glasses, small particles (dirt) are attached to the surface, in some cases, and when the lens is rubbed with a dry cloth, scratch may be generated.

For the recording surface of the optical disc such as a CD, a DVD, or a BD, contact to a corner of a case when putting in and taking out from the case, contact to a corner of a device when putting in and taking out from a reproducing device or a recording device, or contact of tip of a finger (nail) may occur, and the scratch is generated due to the scraping therebetween.

For the solar cell panel or a curved mirror, scratch is generated from various reasons such as the contact with sand, leaves, a tree branch transported by wind, or the contact with insects, since it is exposed to the natural environment.

For the endless belt or roll for the image forming apparatus used for the fixing member, the intermediate transferring member, or the recording medium transporting member of the image forming apparatus, contact to a recording medium such as paper or contact to the other members may occur in the image forming apparatus, and thus scratch is generated due to scraping therebetween.

In addition, the examples are not limited the above-described examples, and if it is an object, a surface of which comes in contact with a foreign material, the scratch is generated on the surface thereof by scraping therebetween.

By providing the resin material according to the exemplary embodiment on the surface of the object which comes in contact with a foreign material as a protective film, the scratch generated due to the contact with the foreign material is efficiently repaired.

Endless Belt

The endless belt for the image forming apparatus according to the exemplary embodiment includes a belt-like base, a resin material according to the exemplary embodiment which is provided on the belt-like base.

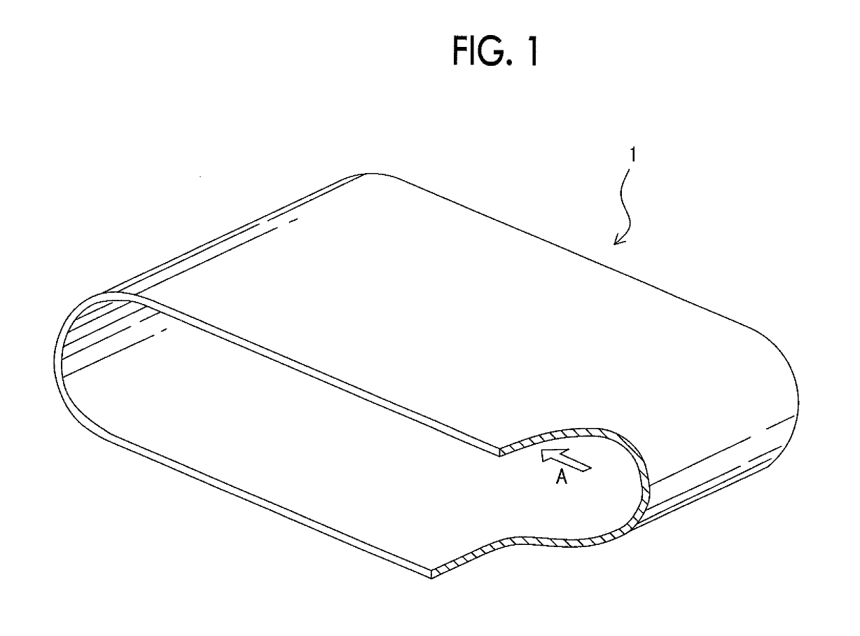

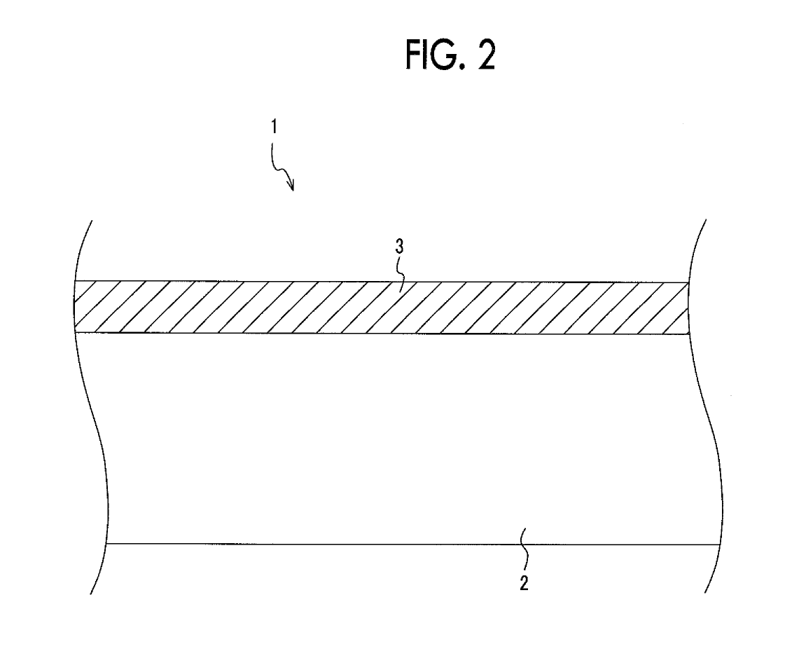

FIG. 1 is a perspective view (a part of which is shown as a cross section) showing the endless belt according to the exemplary embodiment, and FIG. 2 is a cross-sectional view of the endless belt when seen from a direction of an arrow A in FIG. 1.

As shown in FIGS. 1 and 2, an endless belt 1 of the exemplary embodiment is an endless belt including a base 2 and a surface layer 3 laminated on the surface of the base 2.

For the surface layer 3, the resin material according to the exemplary embodiment is used.

The endless belt 1 is used for a fixing belt, an intermediate transferring belt, or a recording medium transporting belt in the image forming apparatus, for example.

Hereinafter, a case of using the endless belt 1 as a fixing belt will be described.

For the material used for the base 2, a material having heat resistance is preferable, and in detail, a material is selected and used from various well-known plastic materials and metal materials.

From the plastic materials, a material called engineering plastic is suitable in general, and a fluorine resin, polyimide (PI), polyamide-imide polybenzimidazole (PBI), polyether etherketone (PEEK), polysulfone (PSU), polyether sulfone (PES), polyphenylene sulfide (PPS), polyether imide (PEI), and wholly aromatic polyester (liquid crystal polymer) are preferable, for example. Among them, thermoset polyimide, thermoplastic polyimide, polyamide-imide, polyether imide, and the fluorine resin which are excellent in mechanical strength, heat resistance, abrasion resistance, and chemical resistance, are preferable.

In addition, the metal material used for the base 2 is not particularly limited, and various metal items or alloy materials are used and SUS, nickel, copper, aluminum, or iron is suitably used. The plural heat-resistant resins or the metal materials may be laminated.

Hereinafter, a case of using the endless belt 1 as an intermediate transferring belt or a recording medium transporting belt will be described.

Examples of the material used for the base 2 include a polyimide resin, a polyamide imide resin, a polyester resin, a polyamide resin, and a fluorine resin, and among them, it is more preferable to use the polyimide resin and the polyamide imide resin. It is only necessary that the base is in the form of a ring (endless), and a joint may be provided or may not be provided, and in general, a thickness of the base 2 is preferably from 0.02 mm to 0.2 mm.

In a case of using the endless belt 1 as the intermediate transferring belt or the recording medium transporting belt of the image forming apparatus, it is preferable to control surface resistivity thereof in a range of 1×10⁹Ω/□ to 1×10¹⁴Ω/□ and volume resistivity thereof in a range of 1×10⁸Ω/□ to 1×10¹³Ω/□. Accordingly, as described above, carbon black such as ketjen black or acetylene black, graphite, metal or alloy such as aluminum, nickel, copper alloy, metal oxide such as tin oxide, zinc oxide, potassium titanate, tin oxide-indium oxide or tin oxide-antimony oxide composite oxide, or a conductive polymer such as Polyaniline, polypyrrole, polysulfone, or polyacetylene is preferably added to the base 2 or the surface layer 3 as a conductive agent, if necessary (herein, “conductivity” of the polymer means that the volume resistivity is less than 10⁷ Ω·cm). The conductive agents are used alone or in combination of two or more kinds.

Herein, the surface resistivity and the volume resistivity are measured according to JIS-K6911 by using a Hiresta UP MCP-450 type UR probe manufactured by Dia Instruments Co., Ltd., under an environment with 55% RH at 22° C.

In a case of using for fixing, the endless belt 1 may contain an elastic layer between the base 2 and the surface layer 3. As the material of the elastic layer, various rubber materials are used, for example. As the various rubber materials, urethane rubber, ethylene.propylene rubber (EPM), silicone rubber, fluorine rubber (FKM), and the like are used, and the silicone rubber excellent in heat resistance and workability is particularly preferable. Examples of the silicone rubber include RTV silicone rubber, HTV silicone rubber, and in detail, polydimethyl silicone rubber (MQ), methylvinyl silicone rubber (VMQ), methylphenyl silicone rubber (PMQ), and fluorosilicone rubber (FVMQ) are used.

In a case of using the endless belt 1 as a fixing belt in an electromagnetic induction type fixing device, a heat generation layer may be provided between the base 2 and the surface layer 3.

As the materials used for the heat generation layer, non-magnetic metals are used, for example, and detailed examples thereof include metal materials such as gold, silver, copper, aluminum, zinc, tin, lead, bismuth, beryllium, antimony, and alloy thereof (alloy containing these).

A thickness of the heat generation layer is preferably in a range of 5 μm to 20 μm, more preferably in a range of 7 μm to 15 μm, and particularly preferably in a range of 8 μm to 12 μm.

Roll

A roll for an image forming apparatus according to the exemplary embodiment includes a cylindrical base, and a resin material according to the exemplary embodiment which is provided on the cylindrical base.

Next, the roll according to the exemplary embodiment will be described. The roll of the exemplary embodiment is a cylindrical roll including a base and a surface layer laminated on a surface of the base.

For the surface layer, the resin material according to the exemplary embodiment is used.

The cylindrical roll is used for a fixing roll, an intermediate transferring roll, or a recording medium transporting roll in the image forming apparatus, for example.

Hereinafter, a case of using the cylindrical roll as a fixing roll will be described.

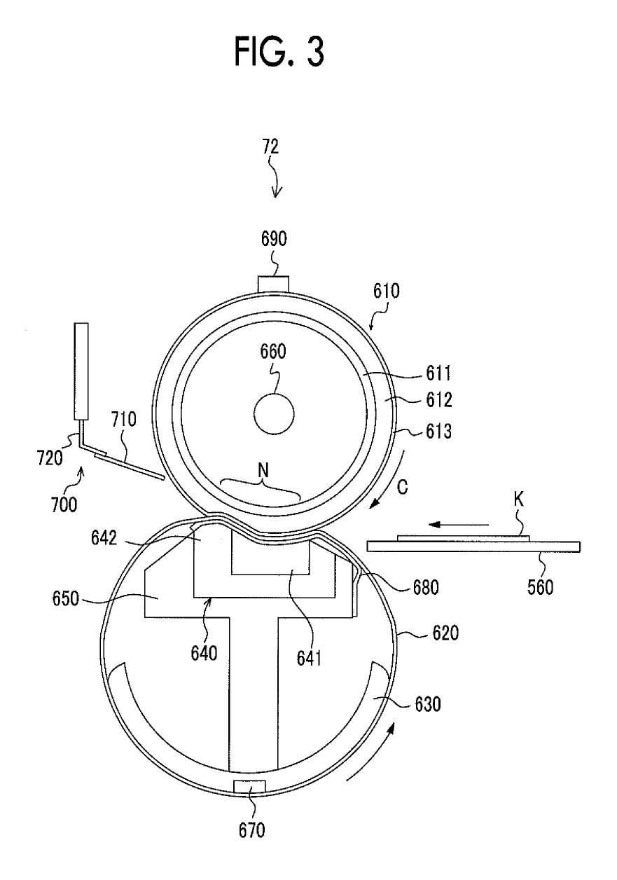

A shape, a structure, a size and the like of a fixing roll 610 as a fixing member shown in FIG. 3 are not particularly limited, and the fixing roll includes a surface layer 613 on a cylindrical core 611. In addition, as shown in FIG. 3, an elastic layer 612 may be provided between the core 611 and the surface layer 613.

As a material of the cylindrical core 611, metal items such as aluminum (for example, A-5052), SUS, iron, and copper, alloy, ceramics, and FRM are used, for example. A fixing device 72 of the exemplary embodiment is configured with a cylinder having an outer diameter φ of 25 mm, a thickness of 0.5 mm, and a length of 360 mm.

The materials of the elastic layer 612 are selected from the well-known materials, and any material may be used as long as it is an elastic body having high heat resistance. In particular, an elastic body such as rubber or elastomer having a degree of rubber hardness of 15° to 45° (JIS-A) is preferably used, and examples thereof include silicone rubber, fluorine rubber, and the like.

In the exemplary embodiment, among the materials described above, silicone rubber is preferable from a viewpoint of small surface tension and excellent elasticity. As the silicone rubber, RTV silicone rubber and HTV silicone rubber are used, for example, and detailed examples thereof include polydimethyl silicone rubber (MQ), methylvinyl silicone rubber (VMQ), methylphenyl silicone rubber (PMQ), fluorosilicone rubber (FVMQ), and the like.

A thickness of the elastic layer 612 is preferably equal to or less than 3 mm, and more preferably in a range of 0.5 mm to 1.5 mm. In the fixing device 72 of the first exemplary embodiment, the HTV silicone rubber having a degree of rubber hardness of 35° (JIS-A) is coated on the core to have a thickness of 72 μm.

A thickness of the surface layer 613 is from 5 μm to 50 μm, and may be from 10 μm to 30 μm.

As described above, as a heating source which heats the fixing roll 610, a halogen lamp 660 is used, for example, and as long as the heating source has a shape or structure, which can be accommodated in the core 611, the heating source is not particularly limited, and is selected according to the object. A surface temperature of the fixing roll 610 heated by the halogen lamp 660 is measured by a thermosensitive device 690 provided on the fixing roll 610, and the temperature is constantly controlled by a control unit. The thermosensitive device 690 are not particularly limited, and a thermistor or a temperature sensor is used, for example.

Fixing Device (Image Fixing Device)

FIG. 3 is a schematic configuration view of the fixing device 72 provided in an image forming apparatus. The fixing device 72 shown in FIG. 3 includes the fixing roll 610 as a rotating body which is rotatably driven, the endless belt 620 (pressurization belt), and a pressure pad 640 to be a pressure member which pressurizes the fixing roll 610 through the endless belt 620. For the pressure pad 640, it is only necessary that the endless belt 620 and the fixing roll 610 be relatively pressurized. Accordingly, the endless belt 620 side may be pressurized to the fixing roll 610 and the fixing roll 610 side may be pressurized to the endless belt 620.

In the fixing roll 610, the halogen lamp 660 as an example of a heating unit which heats a non-fixed toner image in an insertion area is disposed. The heating unit is not limited to the halogen lamp, and the other heat generation member which generates heat may be used.

On the other hand, the thermosensitive device 690 is disposed so as to come in contact with the surface of the fixing roll 610. Based on the temperature measured value by the thermosensitive device 690, the lighting of the halogen lamp 660 is controlled, and the surface temperature of the fixing roll 610 is maintained at a set temperature (for example, 150° C.).

The endless belt 620 is rotatably supported by the pressure pad 640 and a belt travel guide 630 which are disposed in the endless belt, and an edge guide (not shown). The endless belt is disposed so as to contact the fixing roll 610 in a pressurized state in the insertion area.

In the inner side of the endless belt 620, the pressure pad 640 is disposed in a state of being pressurized to the fixing roll 610 through the endless belt 620, and the insertion area N is formed between the pressure pad and the fixing roll 610. In the pressure pad 640, a pre-insertion member 641 for securing the insertion area N with a large width is disposed on an entry side of the insertion area N, and a release insertion member 642 for applying strain to the fixing roll 610 is disposed on an exit side of the insertion area N.

In addition, in order to make sliding friction between the inner periphery surface of the endless belt 620 and the pressure pad 640 small, low frictional sheet 680 is provided on a surface of the pre-insertion member 641 and the release insertion member 642 which comes in contact with the endless belt 620. The pressure pad 640 and the low frictional sheet 680 are held in a metallic holder 650.

Further, the belt travel guide 630 is attached to the holder 650 and is configured so that the endless belt 620 is smoothly rotated. That is, since the belt travel guide 630 comes in contact with the inner periphery surface of the endless belt 620, the belt travel guide is formed with materials having small coefficient of static friction. In addition, the belt travel guide 630 is formed with materials having low thermal conductivity so as to hardly remove heat from the endless belt 620.

The fixing roll 610 is rotated in an arrow C direction by a driving motor (not shown), and by being driven with this rotation, the endless belt 620 is rotated in a direction opposite to the rotation direction of the fixing roll 610. That is, the endless belt 620 is rotated in the counterclockwise direction, while the fixing roll 610 is rotated in the clockwise direction of FIG. 3.

A sheet K having a non-fixed toner image is introduced by a fixing entry guide 560 and is transported to the insertion area N. Then, when the sheet K passes through the insertion area N, the toner image on the sheet K is fixed by the pressure acting in the insertion area N and the heat supplied from the fixing roll 610.

In the fixing device 72, the insertion area N is secured by the pre-insertion member 641 having a concave shape along the outer periphery surface of the fixing roll 610.

In the fixing device 72 according to the exemplary embodiment, by disposing the release insertion member 642 to be protruded with respect to the outer periphery surface of the fixing roll 610, it is configured so that the strain of the fixing roll 610 is locally great in the exit area of the insertion area N. With this configuration, the sheet K after fixation is released from the fixing roll 610.

In addition, as an auxiliary unit of the releasing, a release member 700 is disposed on downstream of the insertion area N of the fixing roll 610. The release member 700 is held by a holder 720 in a state where a release baffle 710 approaches the fixing roll 610 in a direction (counter direction) opposing the rotation direction of the fixing roll 610.

In an image forming apparatus 101 of the exemplary embodiment, the endless belt of the exemplary embodiment is used as the endless belt 620 of the fixing device 72, however, the endless belt of the exemplary embodiment may be used as an intermediate transferring belt 86.

Portable Device

The resin material according to the exemplary embodiment may be used as a protective film of a screen, in a portable device having a screen which displays at least an image.

On the screen (for example, liquid crystal screen) of the portable device such as a mobile phone or a portable game device, scratch is generated due to scraping by the contact with a tip of a finger (nail) when operating, or contact with a tip end of a stick in a case of including the stick for operation. With respect to this, by including the resin material according to the exemplary embodiment as a protective film, even if the scratch is generated, the scratch is repaired, and accordingly, the generation of the scratch remaining permanently on the surface (permanent scratch) is efficiently suppressed.

Window Glass and Body of Car

The resin material according to the exemplary embodiment may be used as a protective film of the window glass of a building or a car. In addition, the resin material according to the exemplary embodiment may be used as a protective film of the body of the car.

For the window glass of the building, or the window glass or body of a car, scratch is generated from various reasons such as the contact with sand, leaves, a tree branch transported by wind, or the contact with insects since it is exposed to the natural environment, or during car washing. With respect to this, by including the resin material according to the exemplary embodiment as a protective film, even if the scratch is generated, the scratch is repaired, and accordingly, the generation of the scratch remaining permanently on the surface (permanent scratch) is efficiently suppressed.

Lens of Glasses

The resin material according to the exemplary embodiment may be used as a protective film of the lens of the glasses.

For the lenses of glasses, small particles (dirt) are attached to the surface, in some cases, and when the lens is rubbed with a dry cloth, scratch may be generated. With respect to this, by including the resin material according to the exemplary embodiment as a protective film, even if the scratch is generated, the scratch is repaired, and accordingly, the generation of the scratch remaining permanently on the surface (permanent scratch) is efficiently suppressed.

Optical Disc

The resin material according to the exemplary embodiment may be used as a protective film of the recording surface of the optical disc.

For the recording surface of the optical disc such as a CD, a DVD, or a BD, contact to a corner of a case when putting in and taking out from the case, contact to a corner of a device when putting in and taking out from a reproducing device or a recording device, or contact of tip of a finger (nail) may occur, and the scratch is generated due to the scraping therebetween. As a result, reading errors occur due to the scratch generated on the recording surface, in some cases. With respect to this, by including the resin material according to the exemplary embodiment as a protective film, even if the scratch is generated, the scratch is repaired, and accordingly, the generation of the scratch remaining permanently on the surface (permanent scratch) is efficiently suppressed. As a result, the generation of the reading errors is also efficiently suppressed.

Solar Cell Panel

The resin material according to the exemplary embodiment may be used as a protective film of the solar cell panel.

For the solar cell panel or a curved mirror, scratch is generated from various reasons such as the contact with sand, leaves, a tree branch transported by wind, or the contact with insects, since it is exposed to a natural environment. With respect to this, by including the resin material according to the exemplary embodiment as a protective film, even if the scratch is generated, the scratch is repaired, and accordingly, the generation of the scratch remaining permanently on the surface (permanent scratch) is efficiently suppressed.

### EXAMPLES

Hereinafter, the exemplary embodiment of the invention will be described in detail with reference to Examples, however, the exemplary embodiment of the invention is not only limited to the following Examples. In addition, hereinafter, “parts” and “%” are based on weight, unless otherwise specified.

### Example 1

### Synthesis of Acrylic Resin Prepolymer A1

A monomer solution consisting of 95 parts of hydroxyethyl methacrylate (HEMA), 510 parts of PLACCEL FM 3 (manufactured by Daicel Corporation), 330 parts of FAMAC6 (manufactured by NOK Corporation, number of fluorine atoms contained in one molecule of monomer: 13) which is a monomer having a fluorine atom (a rate of fluorine atom with respect to the acrylic resin prepolymer is 13.5% by weight), 210 parts of butyl methacrylate (BMA), 27 parts of a polymerization initiator (benzoyl peroxide, BPO), and 300 parts of MEK (methylethyl ketone) is put into a dropping funnel, and is dropped over 3 hours while stirring into 300 parts of MEK under nitrogen reflux to perform polymerization. In addition, liquid consisting of 80 parts of MEK and 4 parts of BPO is dropped over 1 hour and the reaction is completed, and an acrylic resin prepolymer A1 is synthesized.

Formation of Resin Material Sample A1

After mixing the following liquid A and the following liquid B with the following ratio, the following liquid C is additionally added, and defoaming is performed for 10 minutes under the reduced pressure. The resultant is casted on a polyimide film having a thickness of 75 μm and cured for 1 hour at 85° C., and further cured for 30 minutes at 130° C., to obtain a resin material sample A1 having a thickness of 40 μm.
Liquid A (acrylic resin prepolymer A1 liquid, 46.5%, a hydroxyl value of 115): 21.5 parts
Liquid B (polycarbonate polyol, structure “HO—[ROCOO]ₙ—ROH/R═(CH₂)₆” manufactured by Ube Industries, Ltd. product name: ETERNACOLL UH-100, number of functional groups: 2, weight-average molecular weight: 1000, hydroxyl value: 112): 10.3 parts
Liquid C (isocyanate, manufactured by Asahi Kasei Chemicals Corporation, Duranate TKA100, chemical name: polyisocyanurate body of hexamethylene diisocyanate): 7.5 parts (isocyanate in an equivalent amount of the total hydroxyl group of liquid A and liquid B is used)

A ratio (B)/(A) of the total molar amount (A) of the hydroxyl group of the acrylic resin prepolymer of liquid A and the total molar amount (B) of the hydroxyl group of the polyol of liquid B is 1.

### Example 2

A resin material sample A2 is obtained by the method disclosed in Example 1, except for changing ETERNACOLL UH-100 to ETERNACOLL UH-50 (molecular weight of 500), and the amount of liquid C to an amount of liquid C containing isocyanate in an equivalent amount of the total amount of hydroxyl group of liquid A and liquid B in Example 1.

In addition, the number of the functional groups of polyol of liquid B is 2, the weight-average molecular weight is 500, the hydroxyl value is 224, and the ratio (B)/(A) of the total molar amount (A) of the hydroxyl group of the acrylic resin prepolymer of liquid A and the total molar amount (B) of the hydroxyl group of the polyol of liquid B is 1.

### Example 3

A resin material sample A3 is obtained by the method disclosed in Example 1, except for changing ETERNACOLL UH-100 to ETERNACOLL UH-200 (molecular weight of 2000), and the amount of liquid C to an amount of liquid C containing isocyanate in an equivalent amount of the total amount of hydroxyl group of liquid A and liquid B in Example 1.

In addition, the number of the functional groups of polyol of liquid B is 2, the weight-average molecular weight is 2000, the hydroxyl value is 56, and the ratio (B)/(A) of the total molar amount (A) of the hydroxyl group of the acrylic resin prepolymer of liquid A and the total molar amount (B) of the hydroxyl group of the polyol of liquid B is 1.

### Example 4

A resin material sample A4 is obtained by the method disclosed in Example 1, except for changing the amount of ETERNACOLL UH-100 to double, and the amount of liquid C to an amount of liquid C containing isocyanate in an equivalent amount of the total amount of hydroxyl group of liquid A and liquid B in Example 1.

In addition, the number of the functional groups of polyol of liquid B is 2, the weight-average molecular weight is 1000, the hydroxyl value is 112, and the ratio (B)/(A) of the total molar amount (A) of the hydroxyl group of the acrylic resin prepolymer of liquid A and the total molar amount (B) of the hydroxyl group of the polyol of liquid B is 2.

### Example 5

A resin material sample A5 is obtained by the method disclosed in Example 1, except for changing ETERNACOLL UH-100 to EXCENOL EL-1030 (manufactured by Asahi Glass Co., Ltd.), and the amount of liquid C to an amount of liquid C containing isocyanate in an equivalent amount of the total amount of hydroxyl group of liquid A and liquid B in Example 1.

In addition, the number of the functional groups of polyol of liquid B is 2, the weight-average molecular weight is 1000, the hydroxyl value is 160, and the ratio (B)/(A) of the total molar amount (A) of the hydroxyl group of the acrylic resin prepolymer of liquid A and the total molar amount (B) of the hydroxyl group of the polyol of liquid B is 1.

### Example 6

A resin material sample A6 is obtained by the method disclosed in Example 1, except for changing ETERNACOLL UH-100 to PF 656 (manufactured by Kitamura Chemiclas Co., LTd., structure: “HO—[CH₂—C(—CH₃) (—CH₂—OR)—CH₂O]₆—H/R═CH₂CF₂CF₃”), and the amount of liquid C to an amount of liquid C containing isocyanate in an equivalent amount of the total amount of hydroxyl group of liquid A and liquid B in Example 1.

In addition, the number of the functional groups of polyol of liquid B is 2, the weight-average molecular weight is 1410, the hydroxyl value is 79, and the ratio (B)/(A) of the total molar amount (A) of the hydroxyl group of the acrylic resin prepolymer of liquid A and the total molar amount (B) of the hydroxyl group of the polyol of liquid B is 0.2.

### Comparative Example 1

A resin material sample B1 is obtained by the method disclosed in Example 1, except for changing the amount of the liquid B to 0 part and the amount of the liquid C to 3.8 parts, in the “formation of the resin layer sample A1” of Example 1.

### Comparative Example 2

A resin material sample B2 is obtained by the method disclosed in Example 1, except for changing the polyol used for the liquid B to 10.4 parts of PEG-6000J (manufactured by Lion Corporation), and the amount of liquid C to an amount of liquid C containing isocyanate in an equivalent amount of the total amount of hydroxyl group of liquid A and liquid B, in the “formation of the resin layer sample A1” of Example 1.

In addition, the number of the functional groups of polyol of liquid B is 2, the weight-average molecular weight is 6000, the hydroxyl value is 11, and the ratio (B)/(A) of the total molar amount (A) of the hydroxyl group of the acrylic resin prepolymer of liquid A and the total molar amount (B) of the hydroxyl group of the polyol of liquid B is 0.1.

### Comparative Example 3

A resin material sample B3 is obtained by the method disclosed in Example 1, except for changing the polyol used for the liquid 3 to 0.3 parts of ethylene glycol, and the amount of liquid C to an amount of liquid C containing isocyanate in an equivalent amount of the total amount of hydroxyl group of liquid A and liquid B, in the “formation of the resin layer sample A1” of Example 1.

In addition, the number of the functional groups of polyol of liquid B is 2, the weight-average molecular weight is 62, the hydroxyl value is 1839, and the ratio (B)/(A) of the total molar amount (A) of the hydroxyl group of the acrylic resin prepolymer of liquid A and the total molar amount (B) of the hydroxyl group of the polyol of liquid B is 0.5.

Evaluation

For Examples and Comparative Examples, tests for scratch resistance and strength are performed by the following method.

Scratch Resistance Test

The susceptibility to permanent scratch of the obtained resin layer sample is evaluated by the following method.

The obtained resin layer sample is set on a friction player manufactured by Rhesca Corporation. Steel wool of #0000 is attached to the terminal, load of a weight of 30 g is loaded, and then, 5 times of rotation is performed at a circumferential speed of 30 mm/sec, and after 3 minutes, a state of scratches on the surface is evaluated.

A: No scratches

B: One or two faint scratches observed

C: Few faint scratches observed

D: Deep scratches observed

The measurement results are shown in the following Table 1.

Strength Test

The strength of the obtained resin layer sample is evaluated by measuring load bearing, by the following method.

The obtained resin layer sample is set on a friction tester (product name: TRIBOGEAR) manufactured by SHINTO Scientific CO., Ltd. A sapphire needle having curvature of 0.05 is made to move 3 cm on the resin layer sample while weighting at a constant speed (weight of 0 g to 50 g). After two hours, by measuring a length of a scratch remaining on the surface of the resin layer sample, the load for starting scratching is obtained.

A: No scratches with the load of 50 g

B: Scratches observed on the position with the load of equal to or more than 40 g and less than 50 g

C: Scratches observed on the position with the load of equal to or more than 20 g and less than 40 g

D: Scratches observed with the load of less than 20 g

The measurement results are shown in the following Table 1.

TABLE 1

| | |
|---|---|
| Polyol | Evaluation |

| | Molecular | Hydroxyl | Scratch | |
|---|---|---|---|---|
| | weight | value | resistance | Strength |
| Example 1 | 1000 | 112 | A | A |
| Example 2 | 500 | 224 | A | A |
| Example 3 | 2000 | 56 | B | B |
| Example 4 | 1000 | 112 | A | A |
| Example 5 | 1000 | 160 | A | A |
| Example 6 | 1410 | 79 | B | A |
| Comparative | None | | B | D |
| Example 1 | | | | |
| Comparative | 6000 | 11 | D | D |
| Example 2 | | | | |
| Comparative | 62 | 1839 | C | D |
| Example 3 | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin material which is formed by polymerization of an acrylic resin containing aside chain having a hydroxyl group and a side chain having a fluorine atom, at least one kind of polyol having a weight-average molecular weight from 300 to 5000 and selected from compounds represented by the following Formula (A), and an isocyanate:
HO—R¹—X—R¹—OH Formula (A)
wherein in Formula (A), X represents any group selected from the following Formulae (B1) to (B4); and R¹ represents an alkylene group having 1 to 6 carbon atoms, a fluorinated alkylene group having 1 to 8 carbon atoms, or a single bond; in a case where R¹ is a single bond, X represents any group selected from the following Formulae (B2) and (B4): 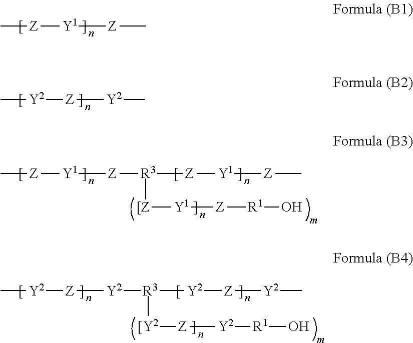
wherein in Formulae (B1) to (B4), Y¹ represents the same group as R¹of Formula (A) or —Si(R²)₂—; Y² represents —Si(R²)₂—; Z represents —OC(═O)O—, —C(═O)O—, or —O—; R² represents —H, —CH₃, or —CF₃; R³ represents an alkyl group having 1 to 6 carbon atoms or a fluorinated alkyl group having 1 to 6 carbon atoms, each having (m+2)-valent bond; m represents an integer from 1 to 3; and n represents an integer equal to or larger than 1; a plurality of n in Formulae (B3) and (B4) may be same with each other or different from each other; and R¹ of Formulae (B3) and (B4) represents the same group as R¹ of Formula (A).

2. The resin material according to claim 1, wherein the polyol is polycarbonate polyol.

3. The resin material according to claim 1, wherein the polyol is polyester polyol.

4. The resin material according to claim 1, wherein the polyol is polyether polyol.

5. The resin material according to claim 1, wherein the polyol is alcohol modified polysilicone.

6. The resin material according to claim 1, wherein a hydroxyl value of the polyol is from 30 mgKOH/g to 400 mgKOH/g.

7. The resin material according to claim 1, wherein a hydroxyl value of the polyol is from 100 mgKOH/g to 250 mgKOH/g.

8. The resin material according to claim 1, wherein an existence rate of a fluorine atom of the acrylic resin is from 0.1% by weight to 50% by weight.

9. The resin material according to claim 1, wherein an existence rate of a fluorine atom of the acrylic resin is from 1% by weight to 20% by weight.

10. The resin material according to claim 1, wherein a hydroxyl value of the acrylic resin is from 50 mgKOH/g to 400 mgKOH/g.

11. The resin material according to claim 1, wherein a hydroxyl value of the acrylic resin is from 70 mgKOH/g to 250 mgKOH/g.

12. The resin material according to claim 1, wherein a hydroxyl value of the acrylic resin is from 100 mgKOH/g to 250 mgKOH/g.

13. The resin material according to claim 1, wherein the acrylic resin is constituted of a constitutional unit derived from a monomer having a fluorine atom, and the number of fluorine atoms contained in one molecule of the monomer having a fluorine atom is from 3 to 17.

14. The resin material according to claim 1, wherein a ratio (b)/(a) of total molar amount (a) of the hydroxyl group contained in the total acrylic resin used for polymerization and total molar amount (b) of the hydroxyl group contained in the total polyol used for polymerization is from 0.1 to 10.

15. The resin material according to claim 1, wherein a ratio (b)/(a) of total molar amount (a) of the hydroxyl group contained in the total acrylic resin used for polymerization and total molar amount (b) of the hydroxyl group contained in the total polyol used for polymerization is from 0.5 to 3.

16. The resin material according to claim 1, wherein molar number of the isocyanate is from 0.5 time to 3 times the total molar number of molar number of the hydroxyl group of the acrylic resin and the hydroxyl group of the polyol.

17. A protective film having the resin material according to claim 1.
